(19) United States
(12) Patent Application Publication
(10) Pub. No.: US 2013/0239137 A1
(43) Pub. Date: Sep. 12, 2013

(54) AUGMENTED BROADCASTING APPARATUS AND METHOD FOR ADVANCE METADATA PROVISION

(71) Applicants: Jeoung Lak HA, Daejeon (KR); Soon Choul KIM, Daejeon (KR); Seoung Chul KIM, Daejeon (KR); Jung Hak KIM, Daejeon (KR); Bum Suk CHOI, Daejeon (KR); Young Ho JEONG, Daejeon (KR); Jin Woo HONG, Daejeon (KR)

(72) Inventors: Jeoung Lak HA, Daejeon (KR); Soon Choul KIM, Daejeon (KR); Seoung Chul KIM, Daejeon (KR); Jung Hak KIM, Daejeon (KR); Bum Suk CHOI, Daejeon (KR); Young Ho JEONG, Daejeon (KR); Jin Woo HONG, Daejeon (KR)

(73) Assignee: Electronics And Telecommunications Research Institute, Daejeon (KR)

(21) Appl. No.: 13/550,981

(22) Filed: Jul. 17, 2012

(30) Foreign Application Priority Data
Mar. 12, 2012 (KR) 10-2012-0024967

(51) Int. Cl. H04N 21/236

(52) U.S. Cl. 725/32

(57) ABSTRACT

Provided is an apparatus and method for providing metadata in advance in order to gain a time required for a receiving terminal to receive augmented content corresponding to the metadata, based on the metadata received over a communication network in a bidirectional digital broadcast. The apparatus may provide a service before a predetermined time for a channel bound service that provides augmented content associated with a broadcast program, or a time-restraint service, such as a quiz program, for which an access to a website may required by a predetermined time. Also, the apparatus may provide metadata of a subsequent program in advance, before a predetermined time when transmitting the broadcast program, whereby a receiving terminal may receive associated information in advance, and a viewer may utilize a website or an augmented content service of a corresponding program, simultaneously with viewing the corresponding program.

### CROSS-REFERENCE TO RELATED APPLICATION

This application claims the benefit of Korean Patent Application No. 10-2012-0024967, filed on Mar. 12, 2012, in the Korean Intellectual Property Office, the disclosure of which is incorporated herein by reference.

### BACKGROUND

1. Field of the Invention

The present invention relates to an augmented broadcasting apparatus and method for advance metadata provision that may provide metadata in advance to gain an amount of time required, by a receiving terminal, to receive augmented content corresponding to the metadata, based on the metadata received via a broadcasting network, in a bidirectional digital broadcast.

2. Description of the Related Art

A smart television additionally provides an Internet function to a conventional digital television broadcast system, thereby enabling viewing of television programming, performing an Internet search, and executing applications or content on the Internet. The smart television may use a broadcasting service via a broadcasting network, and also may use varied content on the Internet via the wired and wireless Internet network connection. In addition, the smart television may be operated as a hub of various digital devices used at home.

An augmented broadcast may increase reality and liveliness for a viewer, and may also enable the viewer to select a desired service directly from services provided by an augmented broadcast CP (Contents Provider), by reconciling augmented content naturally, whereas the viewer views a broadcast program unilaterally provided by a broadcaster, in conventional digital television broadcast system. Accordingly, a television and a portable receiving terminal, hereinafter referred to as a receiving terminal, may receive a conventional broadcast program, hereinafter referred to as basic content, that may be transmitted by a broadcaster, and augmented content that may augment the broadcast program. The broadcaster may transmit the augmented content associated with the broadcast program, and metadata associated with an augmented service, along with the broadcast program.

For example, an augmented broadcast may be used for an educational program. A detailed anatomical chart may be displayed using augmented content in a television program provided in a form of basic content. Detailed information about each organ and a three-dimensional (3D) graphic screen of each organ may be viewed. The 3D graphic information may be rotated at various angles, by the viewer. In particular, such augmented content may not be output depending on a user preference, and only the conventional basic content may be provided.

For an augmented broadcast, augmented content may be produced along with the broadcast program. In this instance, metadata including information about an output time, an output location, a processed event, and the like associated with the augmented content may be generated for the broadcast program. When producing the broadcast program, augmented broadcast producing equipment may be configured to generate the metadata efficiently, and a multiplexer and transmission server may be configured to multiplex and transmit the generated metadata along with the broadcast program. A smart television may output a broadcast program, and may also obtain associated augmented content based on the metadata, and may provide the viewer with the augmented content along with the broadcast program, based on regulations defined by the metadata. The augmented content may be stored in an auxiliary memory of the receiving terminal, or may be provided by a predetermined content provider via the Internet, and related information may be provided using the metadata.

An augmented broadcasting system may transmit and receive basic content, metadata, augmented data over a broadcasting network, and may transmit and receive the metadata and the augmented content over a communication network. In this instance, three methods of using the broadcasting network and the communication network may exist. In one method, the receiving terminal may receive the basic content, the augmented content, and the metadata may be transmitted from the broadcasting network, thereby using an augmented broadcast. In another method, only the basic content and the metadata may be transmitted from the broadcasting network, and the receiving terminal may receive the associated augmented content from the communication network, thereby using the augmented broadcast. In still another method, only the basic content and the metadata may be transmitted from the broadcasting network, and the receiving terminal may receive additional metadata and augmented content from the communication network, thereby using the augmented broadcast. The receiving terminal may access a uniform resource locator (URL) or a uniform resource identifier (URI) based on the metadata received over the broadcasting network to receive the related metadata and the augmented content, by the following the schemes. In one scheme, when the receiving terminal accesses the URL or the URI, the related metadata and the augmented content may be transferred directly. In another scheme, when the receiving terminal accesses the URL or the URI, the user may select desired metadata or augmented content, in a form of a website, or the like.

In a bidirectional digital broadcast, at least one video/audio channel may be multiplexed along with a data channel, and the multiplexed channels may be provided to the viewer over the broadcasting network. In this instance, by incorporating the metadata into the data channel, the user may access a website associated with the program, or may receive augmented content associated with the program, based on the metadata. However, in a conventional technology, when the basic content and the metadata provided in the program are received simultaneously, delays may arise in accessing the home page or reception of the augmented content and thus, interest immersion of the viewer may be interrupted.

### SUMMARY

An aspect of the present invention provides an augmented broadcasting apparatus and method for advance metadata provision that may provide metadata of a subsequent program in advance of a predetermined time, when transmitting a broadcast program, so that a receiving terminal may receive associated information in advance, thereby helping a viewer to utilize a homepage or an augmented content service associated with a corresponding program, simultaneously with viewing the corresponding program.

According to an aspect of the present invention, there is provided an augmented broadcasting apparatus for advance metadata provision, the apparatus including a time collecting unit to collect a time required to receive augmented content, and a control unit to transmit the augmented content in advance based on the collected time, and to multiplex and transmit basic content and metadata.

According to an aspect of the present invention, there is provided an augmented broadcasting method for advance metadata provision, the method including collecting a time required to receive augmented content, and transmitting the augmented content in advance based on the collected time. and multiplexing and transmitting basic content and metadata.

### EFFECT OF THE INVENTION

According to an embodiment of the present invention, by transmitting, in advance of a predetermined point in time, metadata necessary for an access to augmented content to be used for an augmented broadcast, when transmitting an augmented broadcast program, it is possible to guarantee security of augmented contents indicated by the metadata, and to provide a viewer with a stable augmented broadcasting service.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a functional configuration of a digital broadcasting system according to an embodiment of the present invention;

FIG. 2 is a diagram illustrating a reconfigured configuration of the digital broadcasting system of FIG. 1 using concepts of participants in a broadcasting service;

FIG. 3 is a diagram illustrating a relationship of a content provider, a service provider, and a network provider of FIG. 2;

FIG. 4 is a diagram illustrating an example of multiplexing broadcast content according to an embodiment of the present invention;

FIGS. 5A through 5C are diagrams illustrating points in time for transmitting metadata associated with augmented content according to an embodiment of the present invention;

FIG. 6 is a block diagram illustrating a functional configuration of a broadcasting server transmitting augmented broadcast content according to an embodiment of the present invention;

FIG. 7 is a block diagram illustrating a functional configuration of a receiving terminal outputting augmented content according to an embodiment of the present invention;

FIG. 8 is a diagram illustrating a processing process of a terminal receiving an augmented broadcast according to an embodiment of the present invention;

FIG. 9 is a diagram illustrating a process of multiplexing broadcast content when a Moving Picture Experts Group (MPEG)-2 is used according to an embodiment of the present invention; and

FIG. 10 is a flowchart illustrating a method of determining whether augmented broadcast content is to be output, based on received metadata according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

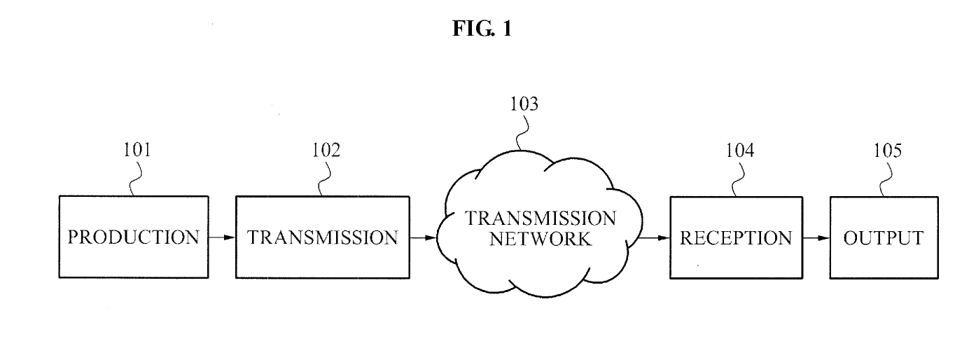

FIG. 1 is a diagram illustrating a functional configuration of a digital broadcasting system according to an embodiment of the present invention.

Broadcast content may be produced by a producer in operation 101, and may be transmitted through a transmitting end of a digital broadcasting system in operation 102. The produced broadcast content may be delivered to a viewer over a transmission network 103. A receiving terminal of the viewer may receive the broadcast content in operation 104, and the received broadcast content may be decoded and output through a display device or a speaker. The digital broadcasting system may generate information about basic content and augmented content, and metadata indicating a relationship between the basic content and the augmented content during production of a broadcast program for a personalized augmented broadcast. When transmitting the broadcast program, the digital broadcasting system may convert the basic content and the augmented content into a format that may be transmitted according to a transmission scheme of the transmission network 103. The transmission network 103 may be provided in a form of a broadcasting network, and may transmit a broadcast program or relay a broadcast program via a relay station. The transmission network 103 may include a communication network to transmit augmented content. The receiving terminal may include another output means, other than the display device or the speaker. The basic content and the augmented content transmitted and received over the transmission network 103 may be encoded and decoded, error-corrected, modulated and demodulated, and the like.

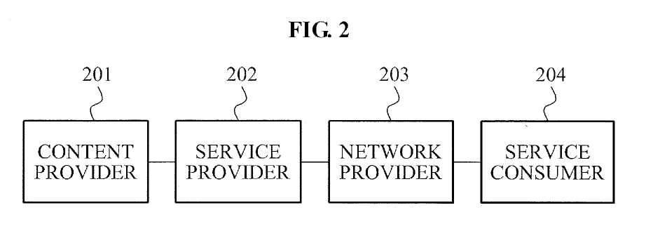

FIG. 2 is a diagram illustrating a reconfigured configuration of the digital broadcasting system of FIG. 1 using concepts of participants in a broadcasting service.

A content provider 201, a business entity providing broadcast content to a broadcaster for sale, and the like, may participate in broadcast content production directly, or may resell produced broadcast content. The broadcast content may be produced by an independent content producer, or an individual. In resale of the broadcast content, the content provider 201 may collect manufactured broadcast contents, and may sell the collected broadcast contents to a service provider 202 or a service consumer 204, directly. The service provider 20, a business entity providing a broadcasting service, may schedule the broadcast contents based on a broadcasting schedule, and may deliver the broadcast content to viewers. A network provider 203 may transmit broadcast content using a transmission line through which the broadcast content may be transmitted. A network used for the transmission line may include a broadcasting network, and a wired and wireless communication network. The service consumer 204, a viewer or a user, may use the broadcasting service or the broadcast contents as an entertainment service. A terminal used by the service consumer 204 may receive content, and also may output the content. A single business entity may become both the content provider 201 and the service provider 202, and also may become both the service provider 202 and the network provider 203. A great number of broadcasters may function as all of the content provider 201, the service provider 202, and the network provider 203.

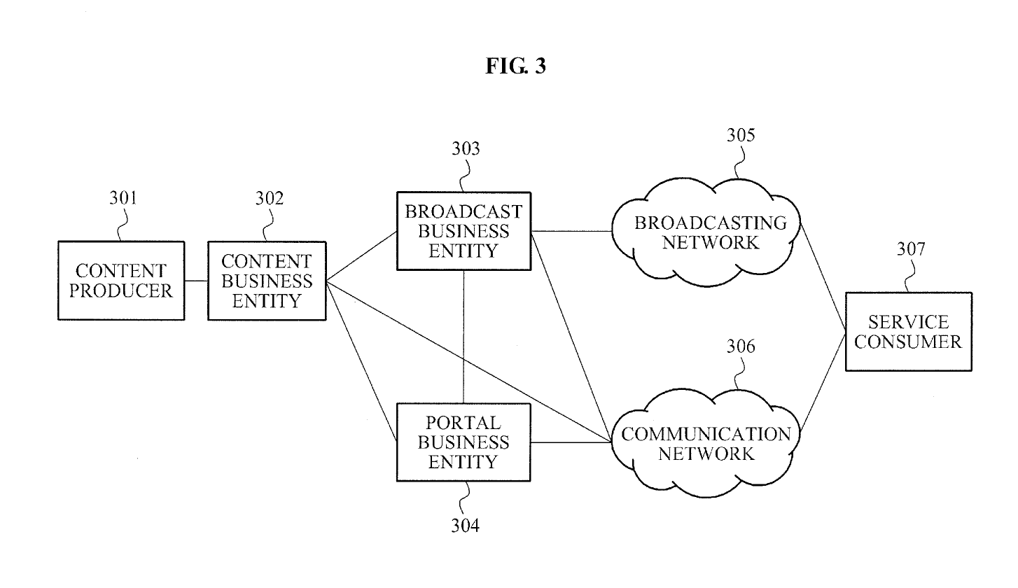

FIG. 3 is a diagram illustrating a relationship of the content provider 201, the service provider 202, and the network provider 203 of FIG. 2. Here, the relationship of the content provider 201, the service provider 202, and the network provider 203 may be referred to as an N:N:N relationship in which a plurality of parties concerned may be entangled.

An embodiment of the present invention may be applied to a smart television or a bidirectional broadcast that may additionally provide information that may not be provided by a broadcasting network 305, using a communication network 306, for example, a wired and wireless communication network. However, when an amount of information to be provided by sensors is sufficiently low so as to be transmitted over a broadcasting network, the information may be serviced only using a conventional digital broadcasting network. The content provider 201 may include at least one content business entity 302. The at least one content business entity 302 may cooperate with at least one content producer 301. The content provider 201 may be the same as the at least one content producer 301. The service provider 202 may include a broadcast business entity 303 or a portal business entity 304. The broadcast business entity 303 may be provided with broadcast content from the at least one content business entity 302, or may produce broadcast content, directly, to provide a broadcasting service. The broadcast content may be provided over the broadcasting network 305. Augmented content enriching the broadcast content may be provided over the broadcasting network 305 when an amount of the augmented content is relatively small. Conversely, when the amount of the augmented content is relatively large, the augmented content may be provided over the communication network 306. The network provider 203 may provide the broadcasting network 305 or the communication network 306, which may provide the broadcast business entity 303, the at least one content business entity 302, and the portal business entity 304 with a path through which broadcast contents may be provided to a viewer. The portal business entity 304 may provide a viewer with augmented broadcast content directly through a contract with the broadcast business entity 303 and the at least one content business entity 302, or may provide the viewer with information about the at least one content business entity 302 having the augmented broadcast content, thereby enabling the viewer to receive the augmented broadcast content from a corresponding content business entity. The augmented broadcast content provided to the service consumer 204 or a service consumer 307, directly by the portal business entity 304 or through the at least one content business entity 302, may be provided over the communication network 306. Different forms of augmented content may be received from a plurality of portal business entities or the at least one content business entity 302, with respect to each basic content. For example, a business entity A may provide information about a golf course using two-dimensional (2D) graphics, and a business entity B may provide information about the golf course using three-dimensional (3D) graphics. In this example, the viewer may selectively use services of the content business entities.

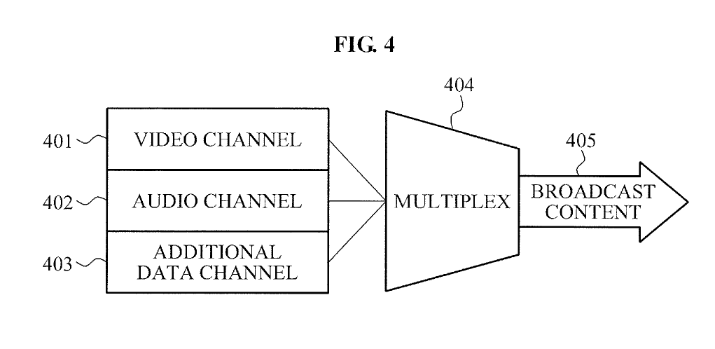

FIG. 4 is a diagram illustrating an example of multiplexing broadcast content according to an embodiment of the present invention.

Broadcast content may be broadcasted in a similar manner to a television broadcast, and may be provided in a form of a video on demand (VOD) in accordance with a demand of a viewer. In a case of the VOD, the broadcast content may be multicasted in accordance with demands of a plurality of viewers. A single piece of broadcast content 405 to be received by a receiving terminal of a viewer may be configured by a multiplexing process 404 at least one video channel 401, at least one audio channel 402, and at least one additional data channel 403, and may be transmitted to a viewer. Each of the at least one video channel 401, the at least one audio channel 402, and the at least one additional data channel 403 may include basic content and augmented content. That is, the at least one video channel 401, the at least one audio channel 402, and the at least one additional data channel 403 may be multiplexed and transmitted when the basic content or the augmented content is transmitted. The basic content and the augmented content may be multiplexed simultaneously or separately, and may be transmitted without multiplexing the basic content and the augmented content depending on cases. By providing information about the augmented content, or information about whether the augmented content is present or absent in additional data of the additional data channel 403, the receiving terminal may receive the augmented content over a communication network. However, when an amount of the augmented content is relatively low, the augmented content may be included in the additional data channel 403, directly, and may be transmitted.

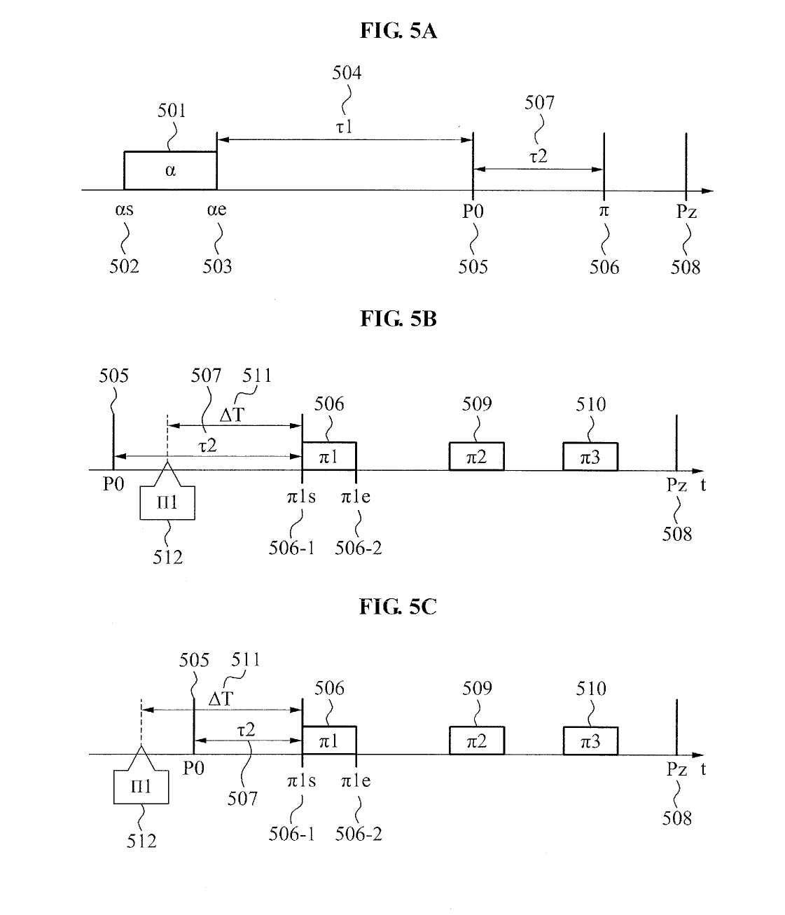

FIGS. 5A through 5C are diagrams illustrating points in time for transmitting metadata associated with augmented content according to an embodiment of the present invention.

A point in time of provision of associated augmented content or an access to a website of a broadcast program will be described in relation to production and broadcast of the broadcasting program, with reference to FIG. 5A.

Referring to a timeline in FIG. 5A, 501 denotes a production period of the broadcast program, and 502 and 503 denote a start of the production period and an end of the production period, respectively. 505 denotes a start of broadcast of the broadcast program. A predetermined time 504 may be utilized until the broadcast program is broadcasted after the production period 501 of the broadcast program elapses. Here, the predetermined time 504 may vary depending on a type of the broadcast program. For example, when the broadcast program corresponds to a live broadcast, a time τ1 from the production period 501 to the start 505 of the broadcast program may be extremely short. When the broadcast program corresponds to a drama having relatively sufficient time, the time τ1 may be relatively long. A point in time 506 of the provision of the augmented content or the access to the website of the broadcast program may appear after a predetermined time 507 elapses from the start 505 of the broadcast of the broadcast program. Here, the point in time 506 may be indicated by π, and the predetermined time 507 may be indicated by τ2. The predetermined time 507, τ2, may vary depending on properties of the broadcast program. However, data used to output the augmented content or contents of the website may need to be secured before the point in time 506, π. The secured data may be stored for a case in which a probability of utilizing the secured data exists, after a termination 508 of the broadcast program. A presorted media may be readily secured before the point in time 506, π, of the provision of the augmented content. However, data to be received over a communication network may need to be secured in advance.

Δt_n denotes a period of time required for a predetermined receiving terminal n to receive data of the augmented content over a communication network, that is, a period of time expended by the receiving terminal n to receive data from a content provider or a portal business entity, over the communication network. Δt_n may include a process delay, a queuing delay, a transmission delay, and a propagation delay. The process delay may refer to a period of time used, by each node on a communication path, to process transferred packets. The queuing delay may refer to a period of time for waiting until the packets transferred to each node on the communication path are processed. The transmission delay may refer to a period of time used to transmit, to a communication link, bits of packets desired to be transferred. The propagation delay may refer to a period of time used to transfer an electrical signal onto a communication line.

Let ΔT be an average of expected times used until augmented content is transmitted, over a communication network, to all receiving terminals receiving the augmented content via an additional data channel of the communication network. A number of receiving terminals accessing the communication network for an augmented broadcast may have different values for delays that the receiving terminals may experience on the network. Accordingly, when ΔT corresponds to a maximum value of Δt_n, all of the receiving terminals may stably receive the augmented content. In addition, ΔT may vary depending on an amount of the augmented content to be transmitted.

The present invention is based on a broadcasting service. Accordingly, when each receiving terminal fails to receive the augmented content over the communication network, the augmented broadcasting service may be unavailable. Let θ_n be a spare time for each of the receiving terminals to receive the augmented content over the communication network. Here, θ_n may include a period of time used when a server transmits metadata, a receiving terminal receives the metadata and transmit a request for augmented content, and a content provider or a server of a portal site receives the augmented content, and a period of time for performing processes, for example, demodulation, demultiplex, error correction, decoding, buffering, and the like, on the augmented content received by the receiving terminal. Then, ΔT=max(Δt_n+θ_n). Here, when it is assumed that all terminals have statistically identical properties, θ_n may be expressed as a constant Θ. That is, ΔT=max(Δt_n+θ_n)=max(Δt_n+Θ). In order to guarantee that the receiving terminals may receive the augmented content over the communication network, and may use the augmented broadcasting service, the metadata for the augmented broadcast may need to be transmitted by a period of ΔT, in advance, over the additional data channel of the communication network.

As another example, when a user receives the metadata, and determines one of a plurality of augmented content providers based on the received metadata, to receive the augmented content from the selected one, ΔT may include max (Δt_n+Θ) as mentioned above, and an additional time required for user interaction.

As still another example, the server may provide a receiving terminal with metadata indicating basic content and source information of the augmented content, and the receiving terminal may download the augmented content by accessing the server using the source information included in the received metadata. When a size of the metadata is relatively great, the server may provide the receiving terminal with the basic content and a portion of the metadata, and the receiving terminal may receive a remaining portion of the metadata by accessing the server using the source information included in the portion of the metadata, and may download the augmented content using the received entire metadata. When the size of the metadata and a size of the augmented content are relatively great, the server may provide the receiving terminal with the basic content, a portion of the metadata, and a portion of the augmented content, and the receiving terminal may store the portion of the augmented content in a memory, receive a remaining portion of the metadata by accessing the server using the source information included in the portion of the metadata, receive a remaining portion of the augmented content using the received entire metadata, and combine the received remaining portion of the augmented content with the portion of the augmented content stored in the memory, thereby facilitating playback of the augmented content. When the size of the augmented content is relatively great, the server may provide the receiving terminal with the basic content, the metadata, and a portion of the augmented content, and the receiving terminal may store the portion of the augmented content in a memory, receive a remaining portion of the augmented content by accessing the server using the source information included in the portion of the metadata, and combine the received remaining portion of the augmented content with the portion of the augmented content stored in the memory, thereby facilitating playback of the augmented content.

A point in time of provision of associated augmented content of a broadcast program will be described in relation to a point in time of using the augmented content, with reference to FIG. 5B.

Referring to a timeline in FIG. 5B, the broadcast program is started at 505 and terminated at 508, and the augmented content may be broadcasted three times, for example, during 506, 509, and 510. Herein, a method of receiving the augmented content during 506 will be described. An output of the augmented content during 506 may be started at a point in time 506-1, that is, π1s, at which the augmented content is started, and may be continued until a point in time 506-2, that is, π1e, at which the augmented content is terminated. In this instance, it may be assumed that the point in time 506-1, π1s, at which the augmented content is started, may occur when a time corresponding to a time period 507 of τ2 elapses after a start 505 of the broadcast program. Here, when ΔT 511 is less than τ2, a point in time 512 Π1 for transmitting metadata for the augmented broadcast may be behind the start 505 of the broadcast program.

Referring to a timeline in FIG. 5C, ΔT 511 is greater than τ2, a point in time 512 Π1 for transmitting metadata for the augmented broadcast may be ahead of the start 505 of the broadcast program.

In order to receive the augmented content, the metadata may need to be transmitted to the additional data channel in advance of the point in time 512 Π1. A transmitting server of the communication network may transmit the metadata using a carousel in advance of the point in time 512 Π1 so that the receiving terminal may receive the corresponding metadata. Here, the carousel may refer to a method of transmitting data periodically since at time at which a viewer turns on a receiver is uncertain. Although the receiving terminal may receive the metadata transmitted after the point in time 512 Π1, the receiving terminal may fail to secure the augmented content before the point in time 506-1 and the augmented broadcasting service may be unavailable at the receiving terminal. When the metadata is transmitted only one time, without applying the carousel, the metadata may be transmitted during the augmented broadcast program in which the augmented content may be used, as described in the example of FIG. 5B. However, metadata associated with augmented content to be used in a subsequent broadcast program may need to be transmitted, in advance, during the current broadcast program, as described in the example of FIG. 5C. When the carousel is applied, the metadata may need to be transmitted before the broadcast program, depending on how early a point in time at which carousel of the metadata is to be started, based on a point in time of consumption of the metadata. A case in which a user may change the channel may correspond to the case in which the metadata may be transmitted only one time without applying the carousel, as described above.

However, when the receiving terminal obtains the augmented content from an auxiliary memory of the receiving terminal, instead of obtaining the augmented content over the communication network, or when the augmented content is transferred as a broadcast over the broadcasting network, a disc access, a process delay at the receiving terminal, or the like before the point in time 506-1 may be received by a predetermined point in time.

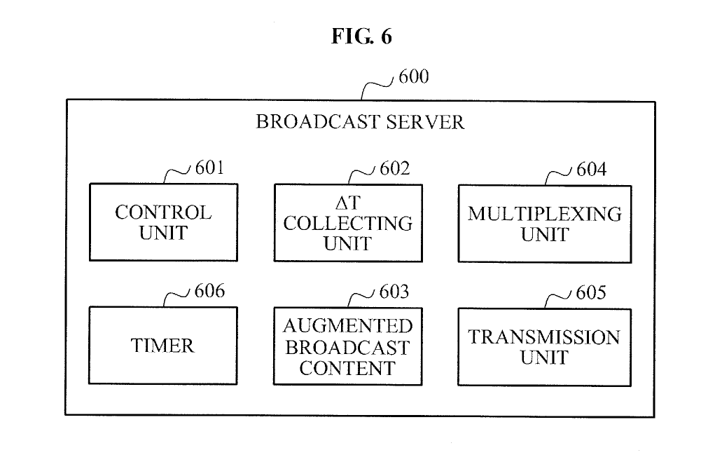

FIG. 6 is a block diagram illustrating a functional configuration of a broadcasting server transmitting augmented broadcast content according to an embodiment of the present invention.

A broadcasting server 600 may enable metadata associated with augmented content to be transmitted before the point in time 512 Π1 for transmitting the metadata for an augmented broadcast, when transmitting a broadcast program. A ΔT collecting unit 602 may calculate ΔT. The ΔT collecting unit 602 may collect Δt_n among a content provider, a portal business entity, and a user system. Collected values may be obtained, online and offline, from the content provider, the portal business entity, or may be obtained from a communication network business entity. The values may be connected by a complete enumeration survey, or a sample survey. In addition, θ_n may be collected by a similar scheme, and a representative value may be obtained using Θ. Since ΔT may be affected by a size of data of the augmented content, ΔT may be expressed by a value in units of bytes or megabytes (Mb). A control unit 601 may search for augmented broadcast content 603, and control basic content and metadata to be multiplexed by a multiplexing unit 604, based on ΔT. The multiplexing process may be performed offline in advance of manufacturing the augmented broadcast content 603, in the spirit of the present invention. When the multiplexing process is not performed at a time of manufacturing the augmented broadcast content 603, basic content and metadata of the augmented content 603 may be arranged at the point of time 506-1 at which consumption of corresponding augmented content may be started, irrespective of ΔT. In this case, when the carousel is applied, a timer 606 may be used. Although the foregoing outlines a scheme before the spirit of the present invention is applied, the timer 606 may be used in a case in which the carousel is applied with respect to general metadata to which augmented content is not applied. A multiplexed augmented broadcast stream may be transmitted through a transmission unit 605. The transmission unit 605 may perform a process, for example, error correction, modulation, and the like.

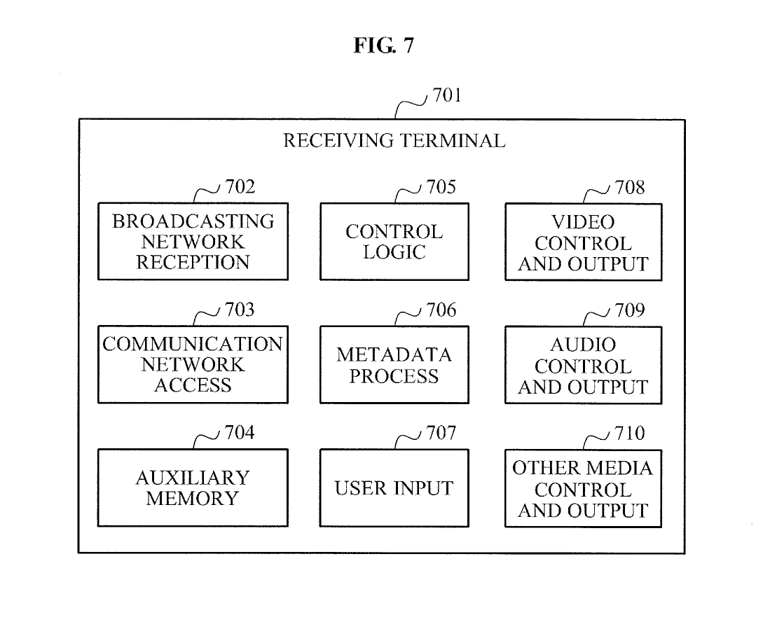

FIG. 7 is a block diagram illustrating a functional configuration of a receiving terminal outputting augmented content according to an embodiment of the present invention.

A receiving terminal 701 may have a broadcasting network reception function 702, and a communication network access function 703. The broadcasting network reception function 702 may have a protocol layer that may receive information about broadcast content transmitted as a digital broadcast. A control logic 705 may interpret other information including basic content transmitted and received over a communication network, determine whether metadata is to be processed, and request processing of the metadata by a metadata process 706. The control logic 705 may receive augmented content over a communication network based on the metadata. The communication network access function 703 may include a function of processing a protocol used for an access to a wired and wireless communication network. The control logic 705 may perform matching, synthesis, synchronization, and the like on the received augmented content with the basic content, and may output results for each media. The matching, the synthesis, and the synchronization between the basic content and the augmented content may be separated from the control logic 705, and may be realized as separate function blocks. A video control and output function 708 may refer to a function of outputting video information of the basic content and the augmented content, simultaneously. An audio control and output function 709 may refer to a function of outputting audio information of the basic content and the augmented content, simultaneously. Other media control and output function 710 may refer to a function of outputting other media information of the basic content and the augmented content. A user input function 707 may process an input of a user at an augmented broadcast receiving terminal, and may process various input schemes, for example, a motion of the user, and an input based on a conventional remote control.

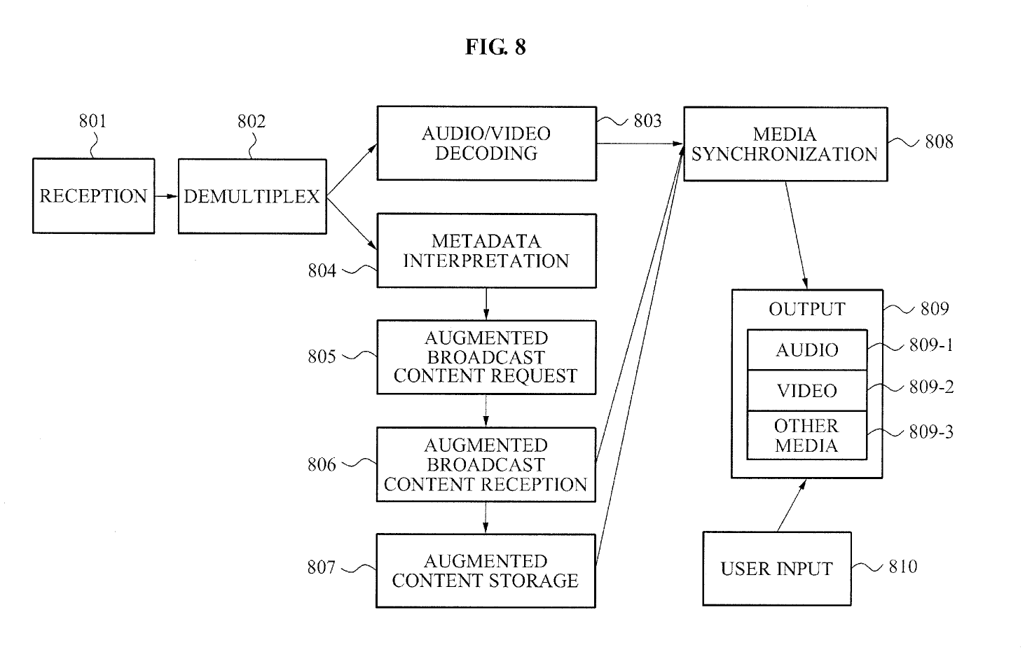

FIG. 8 is a diagram illustrating a processing process of a terminal receiving an augmented broadcast according to an embodiment of the present invention.

When broadcast content is received in operation 801, a terminal may perform demodulation and error correction on the received broadcast content, and may demultiplex the broadcast content in operation 802. When the demultiplexing succeeds, the terminal may decode audio and video. The audio and the video may be decoded independently or simultaneously, depending on encoding schemes. In order to synchronize basic content with augmented content in operation 808, the terminal may buffer the basic content. A predetermined amount of time may be required to receive the augmented content from a communication network based on metadata. Accordingly, for the media synchronization, the terminal may delay playback of the basic content until the augmented content is completely received. In addition, a schedule may be adjusted so that metadata associated with augmented content of a subsequent program may be transmitted in advance while a current program is being broadcasted, whereby the terminal may obtain the augmented content from a server or a content provider to perform synchronization.

The terminal may interpret the metadata in operation 804, and may request corresponding augmented content in operation 805. When the metadata is encoded by a transmission end, a process of decoding the metadata may be performed by a reception end in operation 804. The terminal may request required augmented content in operation 805, based on a result of interpreting the metadata, and may receive a corresponding result in operation 806. The terminal may store the received augmented content in operation 807, as necessary. When the required augmented content is already stored in an auxiliary storage device, or when the required augmented content is already included in data transferred over a communication network, the operations 805 and 806 may be omitted or processed internally. When the augmented content is obtained, the terminal may synchronize, in operation 808, the augmented data with the audio and the video being buffered or obtained in operation 803, and may output synchronized content in operation 809. Depending on a type of the augmented content, the augmented content may be added to the audio decoded in operation 803, and may be output in operation 809-1. Also, the augmented content may be added to the video decoded in operation 803, and may be output in operation 809-2. Further, the augmented content may be output in a form of other media in operation 809-3. The augmented content may be output in at least one of the forms described with respect to operations 809-1, 809-2, and 809-3. The other media may include, for example, oscillation, wind, scent, and the like. An output scheme with respect to the various media may be adjusted by the viewer. As like adjusting a brightness of a screen, or a volume of a speaker, the viewer may adjust an intensity of the output with respect to identical information. When the viewer views a golf course using augmented broadcast content, the terminal may provide views of the course at various angles, according to a user input 810.

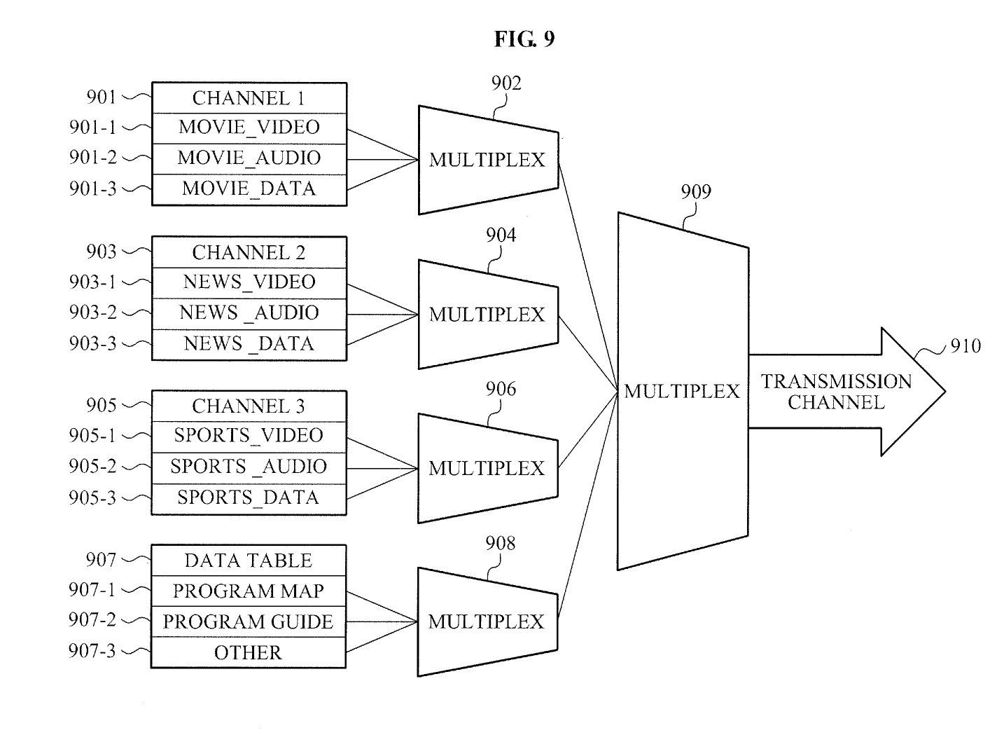

FIG. 9 is a diagram illustrating a process of multiplexing broadcast content when a Moving Picture Experts Group (MPEG)-2 is used according to an embodiment of the present invention.

A transmission channel 910 through which a viewer may receive data may include at least one logical channel, for example, a first channel 901, a second channel 903, and a third channel 905 which may correspond to broadcast contents provided to the viewer, and a data table 907 which may correspond to additional information associated with the broadcast contents included in the transmission channel 910. As an example, when the first channel 901 corresponds to a movie channel, a video 901-1 of the movie, an audio 901-2 of the movie, and metadata 901-3 associated with the movie may be included and multiplexed. The multiplexing process 404 of FIG. 4 may be identical to a multiplexing process 902 of FIG. 9. That is, since the video channel 401, the audio channel 402, and the additional data channel 403 may correspond to the video 901-1, the audio 901-2, and the metadata 901-3, a video 903-1, an audio 903-2, and metadata 903-3, or a video 905-1, an audio 905-2, and metadata 905-3, the aforementioned factors may be construed as being identical functions and devices. As another example, the second channel 903 corresponding to a news channel, and the third channel 905 corresponding to a sports channel may be configured by an identical scheme. The video 901-1, 903-1, and 905-1 or the audio 901-2, 903-2, and 905-2 may be encoded for each channel. Information about each logical channel or the entire transmission channel may be additionally provided as information about the data table 907. For example, the data table 907 may include a program map 907-1 indicating information about a location of each channel in an entire multiplexing stream, program guide 907-2 providing a schedule of a program using the transmission channel 910, and a clock or other information 907-3. Information about each of the first channel 901, the second channel 903, the third channel 905, and the data table 907 may be multiplexed by a corresponding multiplexing process 902, 904, 906, or 908, may be multiplexed again in a lump by a multiplexing process 909, and may be provided in a form of a transmission stream. The augmented contents applied in the present invention may be included in areas of the metadata 901-3, 903-3, and 905-3.

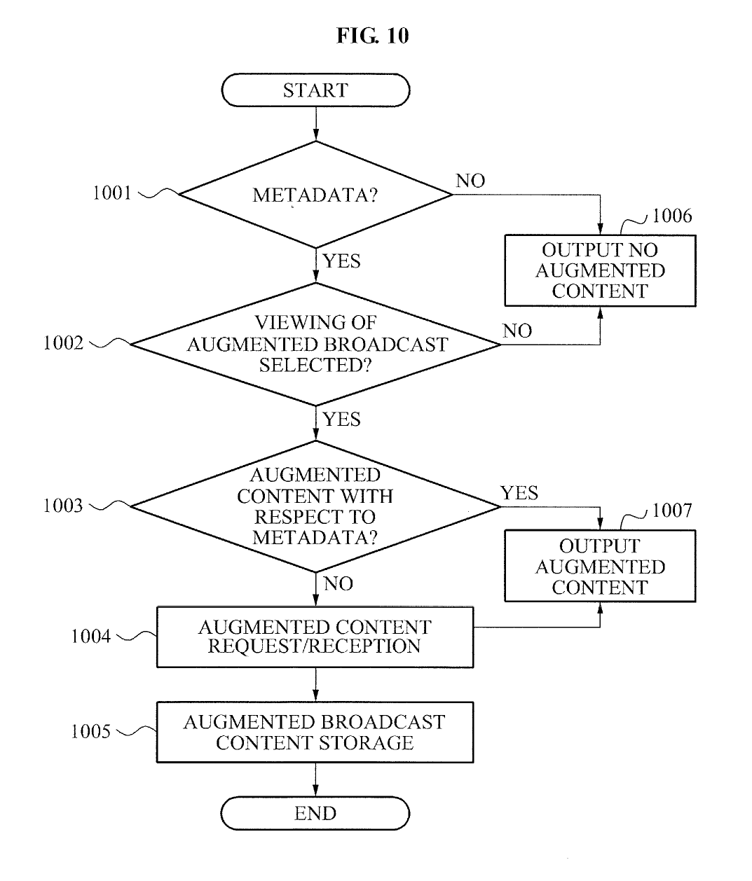

FIG. 10 is a flowchart illustrating a method of determining whether augmented broadcast content is to be output, based on received metadata according to an embodiment of the present invention.

A terminal may demultiplex the broadcast content 405 of FIG. 4 or the broadcast content of FIG. 9 received through the transmission channel 910, and may verify whether metadata is provided, in operation 1001, before interpreting the metadata. When the metadata is absent or augmented content is not included in the metadata, the terminal may not output the augmented content in operation 1006. Although the augmented content exists, when a viewer does not select viewing of the augmented content in operation 1002, the terminal also may not output the augmented content. When the augmented data is present as a result of interpreting the metadata in operation 1003, the terminal may request and receive the augmented content in operation 1004. Also, the terminal may bring the augmented content from an auxiliary storage device. In operation 1005, the terminal may store corresponding augmented content for a future use, as necessary. When the augmented content is received, the terminal may output the augmented content in operation 1007. The operation 1007 may include media synchronization.

Since the metadata may need to be received ΔT in advance, based on a point in time of using the metadata, the metadata may be transmitted at a predetermined point in time. However, when a user turns on a television immediately before a corresponding program is started, the predetermined point in time may already pass, or another channel may be viewed at the predetermined point in time. Accordingly, the metadata may be transferred by incorporating the metadata into an electronic program guide (EPG) providing information about a schedule of the broadcast program. That is, in a digital broadcasting system, when the metadata is transmitted by incorporating the metadata into the programming information of the EPG, a receiving terminal may determine whether an augmented broadcast is to be viewed when selecting or reserving a desired program. The digital broadcasting system may transfer, to the receiving terminal, the metadata set in the programming information of the EPG, thereby enabling the receiving terminal to receive augmented content associated with the metadata in advance.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

1. An augmented broadcasting apparatus for advance metadata provision, the apparatus comprising:
a time collecting unit to collect a time required for a terminal to receive augmented content, and to provide basic content and at least a portion of metadata indicating source information of the augmented content, in view of the collected time, and
wherein the provided basic content and the metadata are transmitted in a same program; and
a control unit to multiplex and transmit the provided basic content and augmented content corresponding to the metadata, and to multiplex the provided basic content, the augmented content corresponding to the metadata, and a remaining portion of the metadata when a portion of the metadata is provided by the time collector.

2. The apparatus of claim 1, wherein when a portion of the augmented content is provided by the time collector, the control unit multiplexes a remaining portion of the augmented content.

3. The apparatus of claim 1, wherein the control unit multiplexes and transmits the augmented content after playback of the basic content when a time at which the playback of the basic content is started is ahead of a point in time at which the augmented content is provided, based on a point in time of playback of the augmented content.

4. The apparatus of claim 1, wherein the control unit multiplexes and transmits the augmented content before playback of the basic content when a time at which the playback of the basic content is started is behind a point in time at which the augmented content is provided, based on a point in time of playback of the augmented content.

5. The apparatus of claim 1, wherein the control unit enables determination of whether the augmented content is to be viewed, by incorporating the metadata into programming information in an electronic program guide, and transmits associated augmented content in advance, based on a result of the determination.

6. An augmented broadcasting method for advance metadata provision, the method comprising:
collecting a time required for a terminal to receive augmented content;
providing basic content and at least a portion of metadata indicating source information of the augmented content, in view of the collected time and
wherein the provided basic content and the at least portion of metadata indicating the source information of the augmented content are transmitted in a same program; and
multiplexing and transmitting the provided basic content and augmented content corresponding to the metadata, and multiplexing the provided basic content, the augmented content corresponding to the metadata, and a remaining portion of the metadata when a portion of the metadata is provided by the time collector.

7. The method of claim 6, wherein when a portion of the augmented content is provided, the multiplexing comprises multiplexing a remaining portion of the augmented content.

8. The method of claim 6, wherein the multiplexing and transmitting comprises:
determining whether a time at which playback of the basic content is started is ahead of a point in time at which the augmented content is provided, based on a point in time of playback of the augmented content; and
multiplexing and transmitting the augmented content after the playback of the basic content when the time at which the playback of the basic content is started is ahead of the point in time at which the augmented content is provided.

9. The method of claim 6, wherein the multiplexing and transmitting comprises:
determining whether a time at which playback of the basic content is started is behind a point in time at which the augmented content is provided, based on a point in time of playback of the augmented content; and
multiplexing and transmitting the augmented content before the playback of the basic content when the time at which the playback of the basic content is started is behind the point in time at which the augmented content is provided.

10. The method of claim 6, wherein the multiplexing and transmitting comprises:
enabling determination of whether the augmented content is to be viewed, by incorporating the metadata into programming information in an electronic program guide; and
transmitting associated augmented content in advance, based on a result of the determination.

11. An augmented broadcasting apparatus for advance metadata provision, the apparatus comprising:
a time collecting unit to collect a time required for a terminal to receive augmented content, and to provide basic content and at least a portion of metadata indicating source information of the augmented content, in view of the collected time, and
wherein the provided basic content and the metadata are transmitted in a same program, and
wherein the same program is received by the terminal; and
a control unit to multiplex and transmit the provided basic content and augmented content corresponding to the metadata, and to multiplex the provided basic content, the augmented content corresponding to the metadata, and a remaining portion of the metadata when a portion of the metadata is provided by the time collector.
